(19) United States
(12) Patent Application Publication
(10) Pub. No.: US 2026/0222140 A1
(43) Pub. Date: Jul. 30, 2026

(54) WAKE-UP INDICATION FOR JOINT COMPUTATION AND COMMUNICATION

(71) Applicant: QUALCOMM Incorporated, San Diego, CA (US)

(72) Inventors: Hua WANG, Basking Ridge, NJ (US); Navid ABEDINI, Basking Ridge, NJ (US); Qing LI, Princeton Junction, NJ (US); Igor GUTMAN, Hod HaSharon (IL); Tao LUO, San Diego, CA (US); Junyi LI, Greentown, PA (US)

(21) Appl. No.: 19/041,711

(22) Filed: Jan. 30, 2025

(51) Int. Cl. H04L 5/00; H04W 24/10; H04W 52/02

(52) U.S. Cl. CPC H04L 5/0048; H04W 24/10; H04W 52/0235

(57) ABSTRACT

Certain aspects of the present disclosure provide techniques for managing cooperative computation and/or communication involving wireless nodes. An example method, performed at a first wireless node, generally includes obtaining signaling associated with coordinated computation involving the first wireless node and a second wireless node, and performing one or more actions based on the signaling.

### INTRODUCTION

Aspects of the present disclosure relate to wireless communications, and more particularly, to managing cooperative computation and/or communication involving wireless nodes.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at an apparatus. The method includes obtaining signaling associated with coordinated computation involving a wireless node and the apparatus; and performing one or more actions based on the signaling.

Another aspect provides a method for wireless communication at an apparatus. The method includes obtaining information regarding coordinated computation involving a first wireless node and at least a second wireless node; and outputting signaling associated with the coordinated computation to the first wireless node.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a general functional framework applied for AI-enabled RAN intelligence.

FIG. 6A illustrates wireless communications without UE cooperation, in accordance with certain aspects of the present disclosure.

FIG. 6B illustrates wireless communications with UE cooperation, in accordance with certain aspects of the present disclosure.

FIG. 7 depicts an example of cooperative communication and/or computation in accordance with certain aspects of the present disclosure.

FIG. 8 is a call flow diagram illustrating example cooperative communication and/or computation, in accordance with certain aspects of the present disclosure.

FIG. 9 depicts example tasks and functions for cooperative communication and/or computation, in accordance with certain aspects of the present disclosure.

FIG. 10 depicts a method for wireless communications.

FIG. 11 depicts a method for wireless communications.

FIG. 12 depicts aspects of an example communications device.

### DETAILED DESCRIPTION

Aspects of the present disclosure relate to wireless communications, and more particularly, to managing cooperative computation and/or communication involving wireless nodes.

Employing cooperation between wireless nodes, such as user equipments (UEs), in wireless communication networks may provide various benefits. For example, such cooperation may help provide mobility support to UEs in networks with limited energy and radio spectrum resources.

UE cooperation generally refers to the ability of UEs to share resources. For example, a cooperating UE may help to increase the effective capability of another UE, referred to herein as a target UE. Collectively, the cooperating UE and target UE may form a virtual UE with greater capability than either of the UEs have separately. Such UE coordination may provide benefits, including improved spatial diversity, improved resource utilization, and improved throughput.

Devices may also cooperate for distributed computing. In such cases, one device may use the computing resources of another device, for example, for computationally-intensive or memory-intensive applications. The cooperating device may be, for example, a UE or an application server in an extended reality (XR) split computing use case example.

Aspects of the present disclosure provide mechanisms that may enhance cooperative computation and communications. In some cases, existing signaling mechanisms may be leveraged to provide an indication for communication or computation between cooperative devices.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

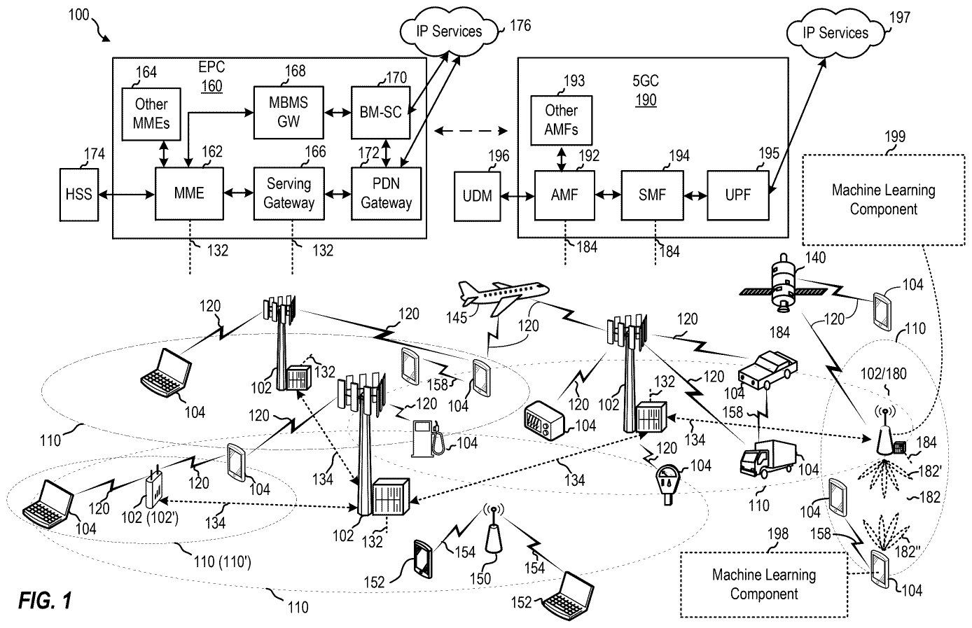

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

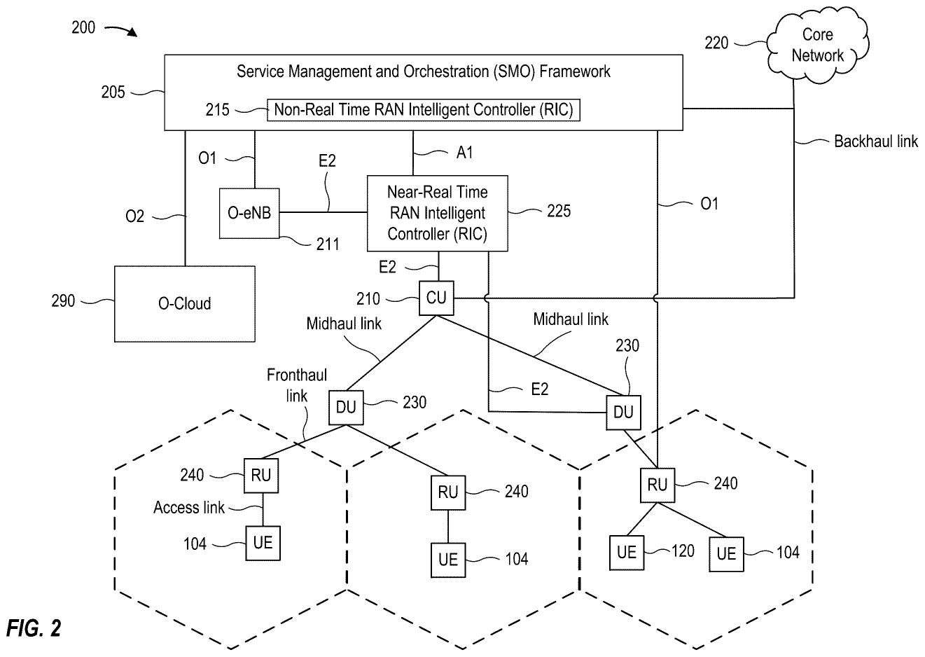

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless. Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

Wireless communication network 100 includes a machine learning component 199, which may perform the operations described herein related to machine learning timelines and/or machine learning concurrent processing. Wireless network 100 further includes a machine learning component 198, which may perform the operations described herein related to machine learning timelines and/or machine learning concurrent processing.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit - User Plane (CU-UP)), control plane functionality (e.g., Central Unit - Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

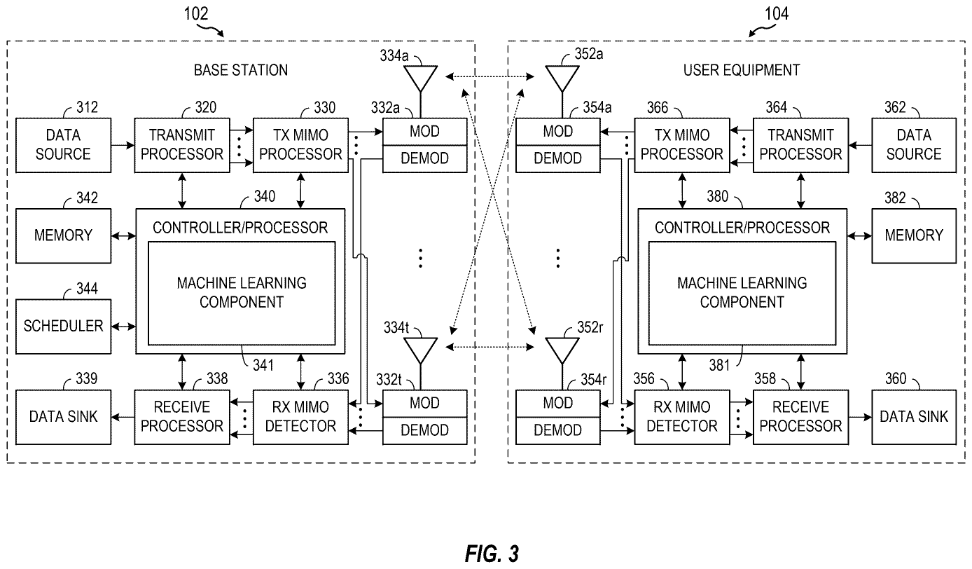

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Base station 102 includes controller/processor 340, which may be configured to implement various functions related to wireless communications. In the depicted example, controller/processor 340 includes machine learning component 241, which may be representative of the machine learning component 199 of FIG. 1. Notably, while depicted as an aspect of controller / processor 340, the machine learning component 341 may be implemented additionally or alternatively in various other aspects of base station 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

User equipment 104 includes controller/processor 380, which may be configured to implement various functions related to wireless communications. In the depicted example, controller/processor 380 includes machine learning component 381, which may be representative of the machine learning component 198 of FIG. 1. Notably, while depicted as an aspect of controller/processor 380, the machine learning component 381 may be implemented additionally or alternatively in various other aspects of user equipment 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

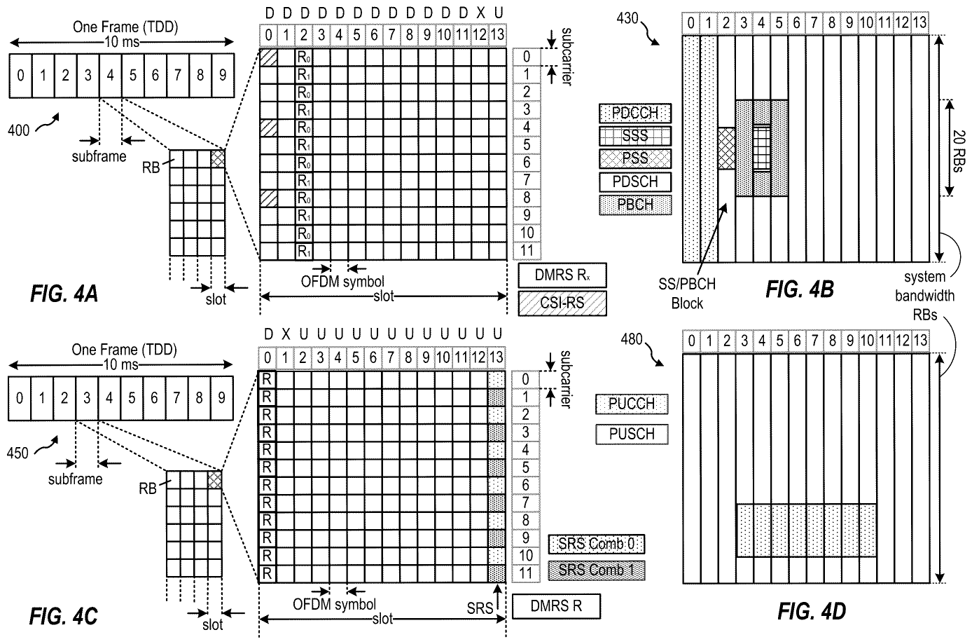

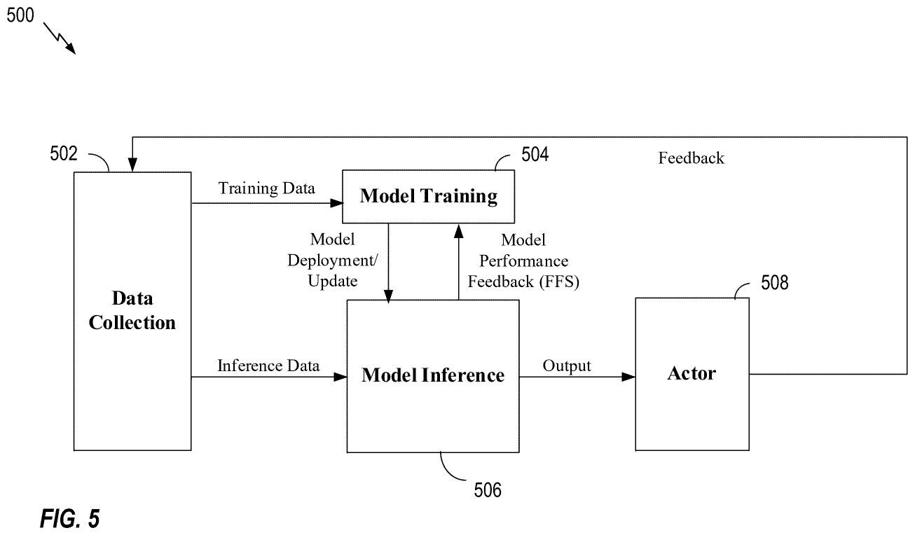

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Ai/ml Functional Framework for Ran Intelligence

The AI/ML functional framework includes a data collection function 502, a model training function 504, a model inference function 506, and an actor function 508, which interoperate to provide a platform for collaboratively applying AI/ML to various procedures in RAN.

The data collection function 502 generally provides input data to the model training function 504 and the model inference function 506. AI/ML algorithm specific data preparation (e.g., data pre-processing and cleaning, formatting, and transformation) may not be carried out in the data collection function 502.

Examples of input data to the data collection function 502 (or other functions) may include measurements from UEs or different network entities, feedback from the actor function, and output from an AI/ML model. In some cases, analysis of data needed at the model training function 504 and the model inference function 506 may be performed at the data collection function 502. As illustrated, the data collection function 502 may deliver training data to the model training function 504 and inference data to the model inference function 506.

The model training function 504 may perform AI/ML model training, validation, and testing, which may generate model performance metrics as part of the model testing procedure. The model training function 504 may also be responsible for data preparation (e.g., data pre-processing and cleaning, formatting, and transformation) based on the training data delivered by the data collection function 502, if required.

The model training function 504 may provide model deployment/update data to the model inference function 506. The model deployment/update data may be used to initially deploy a trained, validated, and tested AI/ML model to the model inference function 506 or to deliver an updated model to the model inference function 506.

As illustrated, the model inference function 506 may provide AI/ML model inference output (e.g., predictions or decisions) to the actor function 508 and may also provide model performance feedback to the model training function 504, at times. The model inference function 506 may also be responsible for data preparation (e.g., data pre-processing and cleaning, formatting, and transformation) based on inference data delivered by the data collection function 502, at times.

The inference output of the AI/ML model may be produced by the model inference function 506. Specific details of this output may be specific in terms of use cases. The model performance feedback may be used for monitoring the performance of the AI/ML model, at times. In some cases, the model performance feedback may be delivered to the model training function 504, for example, if certain information derived from the model inference function is suitable for improvement of the AI/ML model trained in the model training function 504.

The model inference function 506 may signal the outputs of the model to nodes that have requested them (e.g., via subscription), or nodes that take actions based on the output from the model inference function. An AI/ML model used in a model inference function 506 may need to be initially trained, validated and tested by a model training function before deployment. The model training function 504 and model inference function 506 may be able to request specific information to be used to train or execute the AI/ML algorithm and to avoid reception of unnecessary information. The nature of such information may depend on the use case and on the AI/ML algorithm.

The actor function 508 may receive the output from the model inference function 506, which may trigger or perform corresponding actions. The actor function 508 may trigger actions directed to other entities or to itself. The feedback generated by the actor function 508 may provide information used to derive training data, inference data or to monitor the performance of the AI/ML Model. As noted above, input data for a data collection function 502 may include this feedback from the actor function 508. The feedback from the actor function 508 or other network entities (via Data Collection function) may also be used at the model inference function 506.

The AI/ML functional framework 500 may be deployed in various RAN intelligence-based use cases. Such use cases may include CSI feedback enhancement, enhanced beam management (BM), positioning and location (Pos-Loc) accuracy enhancement, and various other use cases.

In certain aspects, a UE or a BS may perform ML-based beam prediction using continuous measured or reported L1-RSRP in time domain. In some cases, a pre-trained deep neural network (DNN) model may be used for such ML-based predictive beam management.

Traditionally, beam qualities and failures are identified through measurement reports carried by relevant downlink (DL) and uplink (UL) reference signals (e.g., SSB, CSI-RS, RSRP), which increase beam selection latency and beam management overhead, while at the same beam selection accuracy may be limited due to restrictions on power and overhead that may cause poor system performance.

Instead, the AI/ML based predictive beam management may reduce the amount of reference signal transmissions used to predict non-measured beam qualities and future possibility of beam blockage/failure. In predictive beam management, beam prediction may be a highly non-linear problem, which may be efficiently solved by the pre-trained DNN model that may predict future beam qualities, for example, based on a UE moving speed and trajectory that is difficult to be modeled through statistical processing methods.

### Introduction to User Equipment (UE) Cooperation

The idea of employing cooperation in wireless communication networks has emerged in response to user mobility support and limited energy and radio spectrum resources, which pose challenges in the development of wireless communication networks and services in terms of capacity and performance.

Cooperative wireless communication may involve a wireless network where wireless agents, e.g., user equipments (UEs), increase their effective quality of service (measured at the physical (PHY) layer by bit error rates, block error rates, or outage probability) via cooperation. In a cooperative communication system, each UE is assumed to transmit data as well as act as a cooperative agent for another UE.

Mobile wireless channels suffer from fading, meaning that signal attenuation can vary significantly over the course of a given transmission. By transmitting independent copies of a signal, cooperating UEs may combat the deleterious effects of fading through signal diversity. In particular, spatial diversity may be generated by transmitting signals from different locations, thus allowing independently faded versions of the signal at the receiver. However, many wireless devices (including UEs) may be limited by size and/or cost to reduced processing resources (e.g., limited to one antenna). Accordingly, cooperative communication has been proposed to enable devices, such as single antenna UEs, in a multi-user environment to share their antennas and generate a virtual multiple-antenna transmitter (e.g., a virtual UE) that allows the UEs to achieve spatial diversity. This may represent increased resource utilization. In other words, idle UEs cooperate with active UEs to create a single virtual UE in order to utilize full network throughput.

For example, for cooperative communication, two UEs may be communicating with a same network entity (e.g., a base station). Each UE has one antenna and cannot individually generate spatial diversity. However, it may be possible for one UE to receive information from the other UE, in which case the receiving UE can forward some version of the information from the other UE along with its own data to the network entity. Because the fading paths from two UEs are statistically independent, this generates spatial diversity. Further, a cooperative link established between the two UEs may use unlicensed spectrum to ensure all licensed spectrum remains available to the network.

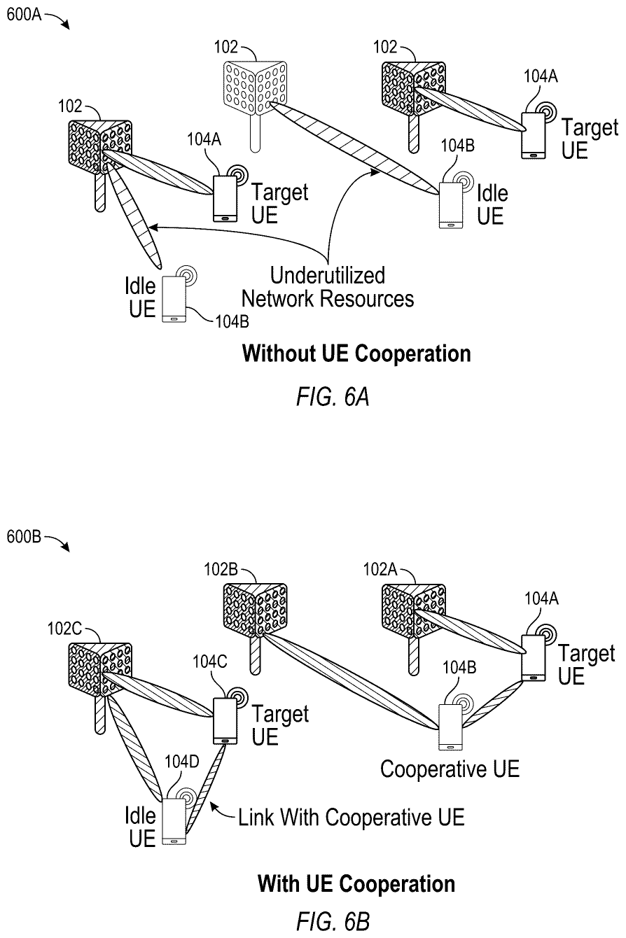

FIG. 6A illustrates an example wireless communications network 600A without UE cooperation, in accordance with certain aspects of the present disclosure. As shown in FIG. 6A, a target UE (e.g., such as UE 104a illustrated in wireless communication network 100 of FIG. 1) and an idle UE (e.g., such as UE 104b illustrated in wireless communication network 100 of FIG. 1) may each communicate with a network entity (e.g., such as BS 102 illustrated in wireless communication network 100 of FIG. 1). As shown, however, because target UE 104a and idle UE 104b do not establish a cooperative link between each other, in this example, network resources may be under-utilized, and thus, throughput may be limited.

In contrast, FIG. 6B illustrates an example wireless communications network 600B with UE cooperation, in accordance with certain aspects of the present disclosure. In the example shown in FIG. 6B, target UE 104a and cooperative UE 104b may establish a cooperation connection to utilize full network throughput. Further, as described above, the link between target UE 104a and cooperative UE 104b may allow for use of unlicensed spectrum.

In certain aspects, cooperative UE updates (as well as UE capability updates) may be transparent to a network entity (e.g., gNB), such as in physical layer (PHY, Layer 1, or L1) or medium access control (MAC) layer (Layer 2 or L2) based solutions. For example, a cooperative UE (e.g., a UE which had previously established a cooperation connection with a target UE) may be removed and/or a cooperation candidate UE may establish a cooperation connection with a target UE (e.g., causing the cooperation candidate UE to be a cooperative UE with the target UE) without the network entity's awareness.

In this case, a multiple-transmission reception point (multi-TRP) framework may be used. In other words, cooperating UEs may access wireless networks via multiple TRPs to help support increased mobile data traffic and enhance the coverage. Multi-TRPs may be used to implement one or more macro-cells, small cells, pico-cells, or femto-cells, and may include remote radio heads, relay nodes, and the like.

In certain other aspects, UE capability updates may be reported to the network entity in higher layer (e.g., Layer 3 or L3 or higher layer) based solutions. For example, in such cases, a cooperative UE may not be removed and/or a cooperation candidate UE may not establish a cooperation connection with a target UE without the network entity's awareness. In this case, a UE capability update reported to the network entity may be UE-controlled. For example, a target UE may select a cooperative candidate UE to establish a cooperation connection with. The target UE may establish a cooperation connection with the selected cooperative candidate UE to create a single virtual UE. The target UE may then transmit a capability update to the network entity, to reflect the additional capability of the virtual UE (relative to the target UE alone). Example Wake-up Indication for Joint Computation and Communication

As described above, a cooperating UE may help to increase the effective capability of another UE (a target UE). Such UE coordination may provide benefits, including improved spatial diversity, improved resource utilization, and improved throughput.

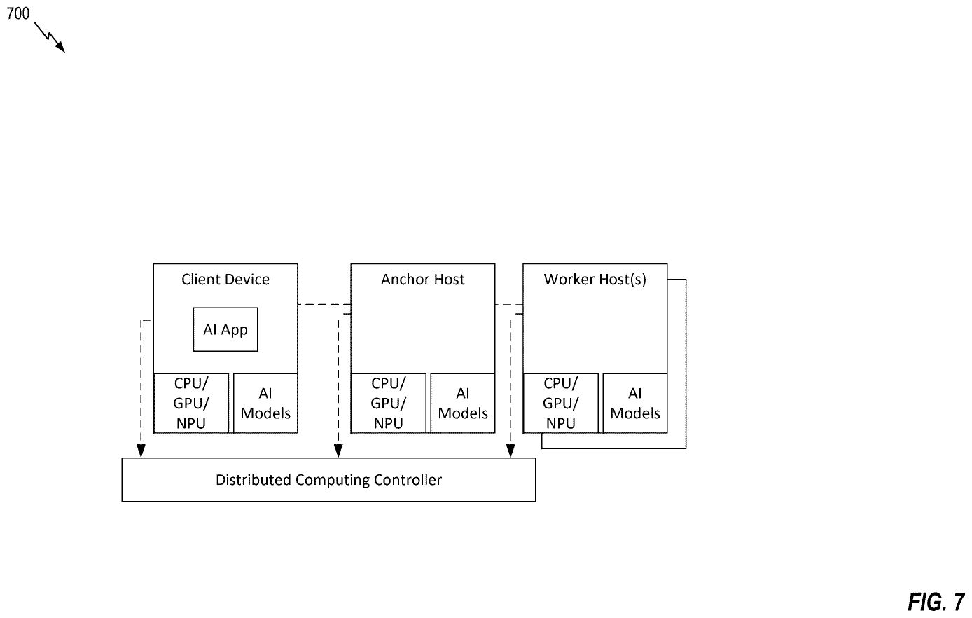

Devices may also cooperate for distributed computing, allowing one device to use the computing resources of another device for computationally-intensive or memory-intensive applications. For example, FIG. 7 illustrates an example distributed computing system 700, in which a client device may use computing resources (e.g., CPU/GPU/NPU) of an anchor host and/or a worker host. As illustrated, a distributed computing controller may help coordinate between the client device, anchor host, and worker host.

For device cooperation, a network and cooperated devices typically need to exchange instructions and data for the cooperative task. In certain cases, the communication between the network and cooperative UEs for this purpose may involve a small amount of data (or even 1 bit).

As an example, the network may send a message to a UE to indicate an intent for cooperation (e.g., an indication that UE is to cooperate with another UE). In such cases, the intent can be indicated using just 1 bit.

As another example, the network may send a message to a UE that serves as a wake up message. In other words, this message may let the UE perform certain initialization procedures or functions for a certain task that is part of the cooperative effort. An example of such initialization may be the loading of model parameters and a key-value (KV) cache for a large language model (LLM) inference. In such cases, the type of LLM model and KV cache can be indicated using a few bits.

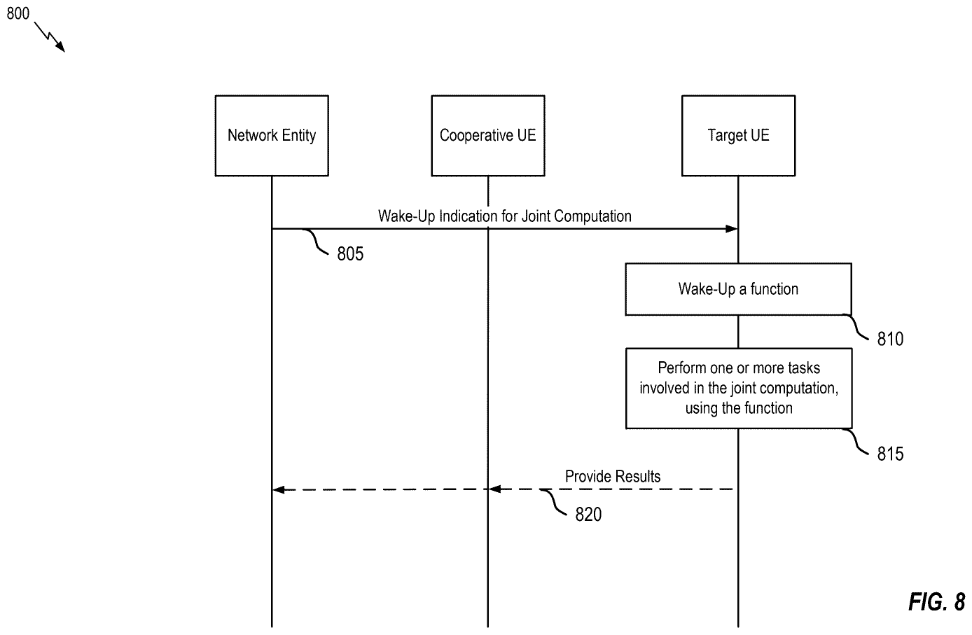

FIG. 8 depicts an example call flow diagram 800, in accordance with certain aspects of the present disclosure. In some aspects, the (cooperative and target) UEs shown in FIG. 8 may be an examples of the UE 104 depicted and described with respect to FIGS. 1 and 3. In some aspects, the network entity shown in FIG. may be an example of the BS 102 (e.g., a gNB) depicted and described with respect to FIGS. 1 and 3 or a disaggregated base station depicted and described with respect to FIG. 2.

As illustrated at 805, the network entity may transmit signaling indicating an intent for the target UE to participate in joint computation with the cooperative UE. As illustrated at 810, the target UE may wake-up a function in response to the wake-up indication.

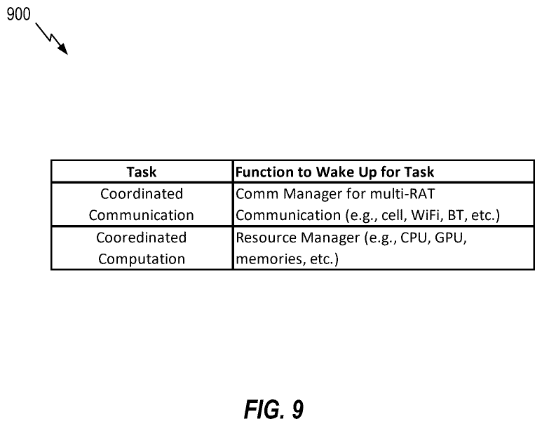

As illustrated in table 900 of FIG. 9, the type of function that is awakened may depend on the type of coordination and task involved. For example, for coordinated communication, a communication manager may be awakened for multi-RAT communication (e.g., cell, WiFi, and/or Bluetooth). For coordinated computation, a resource manager may be awakened to enable one or more resources at the target UE (e.g., CPU, GPU, and/or memories).

Returning to FIG. 8, at 815, the target UE performs one or more tasks involved in the joint computation, using the function. As illustrated at 820, in some cases, the target UE may provide results of the tasks (to the cooperative UE and/or the network entity).

In some cases, physical (PHY/L1), medium access control (MAC/L2), and/or radio resource control (RRC) may be leveraged to provide an indication (of an intent) for communication or computation between cooperative devices.

Exactly how the signaling is provided and what information is provided may depend on the particular scenario and state the UEs are in. For example, for a UE in inactive/idle state, the network may include information bits (indicating the intent for joint computation) in the paging signal. In such cases, the UE may not need to establish a connection to the network if no communication connection establishment is needed.

For a UE in a connected discontinuous reception (CDRX), the network may include those bits in a wake-up signal (WUS). This WUS may be designed to indicate the UE is to wake up resources for computation not for radio communication. Thus, the UE may not need to wake up the main radio.

For a UE in active mode, the network may send (L1/L2/L3) signaling to let the UE perform some form of computation initialization. For example, the signaling may be designed to wake up the UE from a computation sleep mode and load saved state information into memory. This initialization may be performed in preparation of the cooperative computation task in order to reduce latency. As an alternative, the network could use the data plane to send a message to the application layer for the cooperative task, which may take more time.

In some cases, the network may use broadcast L1/L2/L3 signaling. Such signaling may include, for example, group paging, group WUS, or group PDCCH for cooperative computation services to a group of cooperative UEs. In some cases, the broadcast signaling may also be used in service discovery. The network may not know which UE is willing to cooperatively provide a service. Thus, the network may send broadcast signals to a set of UEs, and the UEs willing to participate in the cooperation can reply.

According to certain aspects, the L1/L2/L3 signaling may be used to control (e.g., initiate/trigger/resume/stop) a computation task or to indicate an intent for another device.

In some cases, the signal carried in L1/L2/L3 may only indicate the intent of the signal. For example, the intent of signal may be just to signal that another device may want to interact with this device (e.g., via splitting computation or offloading computation).

In some cases, the signaling may indicate a target UE should stop a task. For example, The L1/L2/L3 signal may indicate that certain functions are not needed and can be put into sleep mode.

The L1/L2/L3 signal may convey various types of information. For example, this information may include an ID of the UE that is the intended recipient of the signal. In some cases, this ID can be derived from a computation entity ID from a computation service layer. As another example, this ID may be a RNTI from a network entity (e.g., gNB) for communication connection.

The information may also include a type of the signal. For example, the information may indicate that the signal is to initiate, trigger, resume, stop, or put to sleep a task involved in cooperative computation or communication. In some cases, the information may indicate that a purpose of the signal is to indicate an intent for computation or communication or both.

In some cases, the information may indicate a list of tasks or functions. For example, the tasks may include an LLM inference task or a UE relaying task.

There are also various options for the type and format of the L1/L2/L3 signal. For example, from a network entity (e.g., a gNB), an L1 signal may be a WUS based on a DCI, a dedicated wake up radio (WUR) friendly WUS, or a new format of DCI. An L2 signal may be a new format of a MAC control element (MAC CE). An L3 signal may include a new UE reconfiguration RRC message.

From a peer (cooperative UE), various types of signals may be used to convey such information. For example, such signals may include sidelink, WiFi, and/or Bluetooth. In some cases, groupcast signals may be used for a group of UEs.

Different tasks may have different times for initialization. According to certain aspects, a UE may report the time needed for initialization for a certain task to the device sending the L1/L2/L3 signal (e.g., the gNB or its peer UE). In some cases, a device may have several different sleep modes for certain functions. According to certain aspects, a UE may report the time needed for each function to wake up from different sleeping mode to the device sending the L1/L2/L3 wake-up signal (e.g., the gNB or its peer UE). This type of reported information (regarding the time needed for initialization of certain tasks or time needed to wake up a sleeping function) may allow the device sending the L1/L2/L3 signal to schedule the transmission of the signal for the targeted UE to have enough time to perform operations for initialization and/or wake-up (such as memory refresh, power up CPU/GPU, etc.).

According to certain aspects, when some functions of a device go into a sleep mode, the device may send a message (e.g., a go-to-sleep message) to the network and/or its peer device. Such a message may include the type of sleeping mode the function is entering (or has entered) into, how long the function will be in the sleeping mode, and similar such information.

According to certain aspects, when the function of a device wakes up from a sleep mode before a wake-up time that was previously reported (to the network and/or its peer device) due to local activities, the device may send a message to inform the network and/or its peer device about this wake-up.

According to certain aspects, a network entity and/or peer device may use the sleep and/or wake-up information described above to decide if and when a wake-up signal transmission for a given function is needed. In some cases, if the network entity and/or peer device need a target device to perform a certain function, the network entity and/or peer device may send a wake-up signal for that function to the target UE based on a timer. The timer may be calculated based on a difference of the current time and the last time of interaction with this function of the target UE.

According to certain aspects, the L1/L2/L3 signal may be used to suggest that the target device should put certain functions into sleeping mode. In some cases, a cooperative UE may be assigned tasks to be performed at specific, pre-determined times. When there are no tasks, the network entity or peer UE may send a L1/L2/L3 sleeping signal to trigger the UE to put the functions into sleep mode in order to save power. The UE may decide to enter a sleep mode based on its own local tasks and conditions. The sleeping signal can include information such as the sleeping mode, the maximum sleeping time, and the like.

According to certain aspects, a network entity may configure the sleep and wake-up schedule for the UE for communication and/or computation. For example, a gNB may use a SIB to broadcast that it supports the L1/L2/L3 signaling to initiate/trigger/resume/stop a task or indicate an intent for another device. In some cases, the UE may use this SIB information as a factor in cell selection (e.g., to select a cell that supports such a feature). In some cases, a UE may indicate its capability of supporting such features (that it supports the L1/L2/L3 signaling to initiate/trigger/resume/stop a task or indicate an intent for it).

According to certain aspects, certain measures may be used to try and protect the security on L1/L2/L3 signal. For example, for a UE in a cooperative group, the Access and Mobility Management Function (AMF) may verify a UE's identity through registration and authentication.

To protect L1 signaling, a specific radio network temporary identifier (RNTI) may be used for the wake up signal. To protect L2 signaling, the transmitter (Tx) ID and/or receiver (Rx) ID may be used in the wake up MAC CE for identification. In such cases, each UE may maintain a list of valid wake up signal Tx IDs. To protect L3 signaling, encryption may be used. Further, for L1 and L2 signaling, various physical layer security measures may be used.

### Example Operations

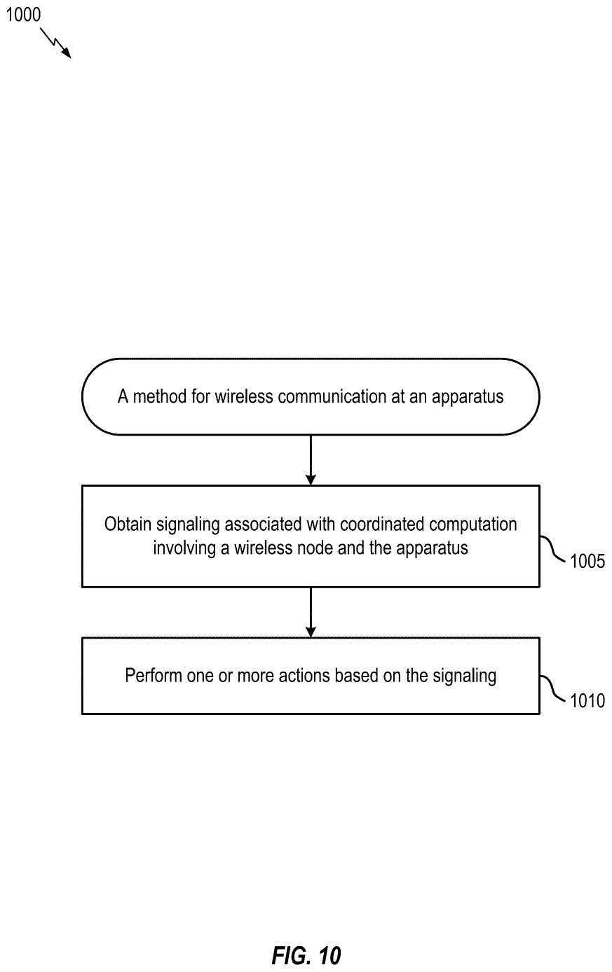

FIG. 10 shows an example of a method 1000 of wireless communication at an apparatus. In some examples, the apparatus is a user equipment, such as a UE 104 of FIGS. 1 and 3. In some examples, the apparatus is a network entity, such as a BS 102 of FIGS. 1 and 3, or a disaggregated base station as discussed with respect to FIG. 2.

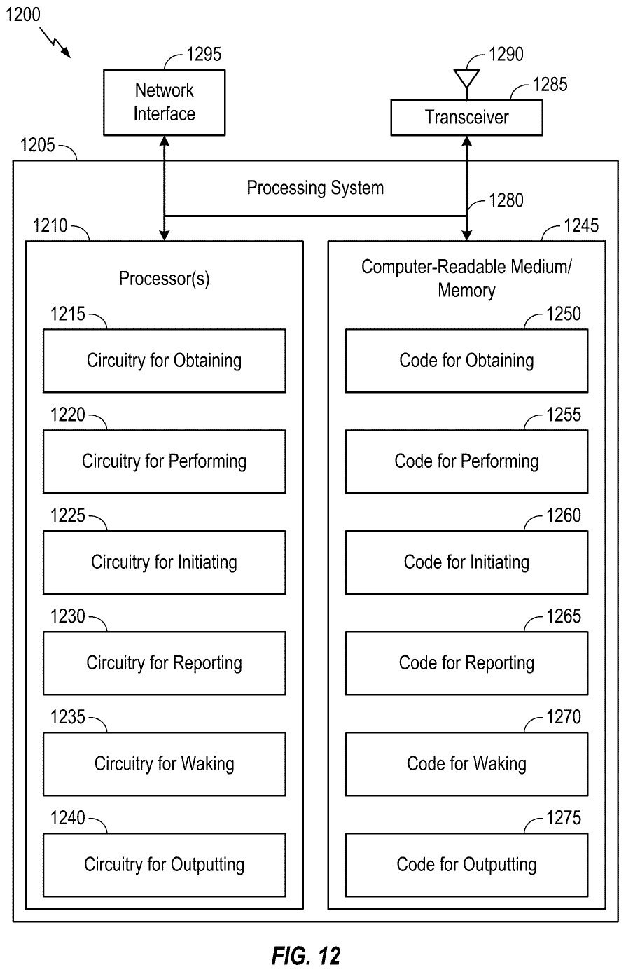

Method 1000 begins at step 1005 with obtaining signaling associated with coordinated computation involving a wireless node and the apparatus. In some cases, the operations of this step refer to, or may be performed by, circuitry for obtaining and/or code for obtaining as described with reference to FIG. 12.

Method 1000 then proceeds to step 1010 with performing one or more actions based on the signaling. In some cases, the operations of this step refer to, or may be performed by, circuitry for performing and/or code for performing as described with reference to FIG. 12.

In some aspects, the signaling comprises at least one of: a paging signal; a wake-up signal; unicast signaling; multicast signaling; or broadcast signaling.

In some aspects, the signaling indicates an intent of the wireless node to participate in the coordinated computation with the apparatus.

In some aspects, the coordinated computation comprises at least one task involving the apparatus; and the one or more actions comprise at least one of initiating, resuming, or stopping the task.

In some aspects, the one or more actions further comprise waking up at least one function at the apparatus in preparation of performing the at least one task.

In some aspects, the signaling indicates at least one of the at least one task or the at least one function.

In some aspects, the method 1000 further includes reporting a time needed for at least one of: initialization of the at least one task. In some cases, the operations of this step refer to, or may be performed by, circuitry for reporting and/or code for reporting as described with reference to FIG. 12.

In some aspects, the method 1000 further includes waking up for the at least one function. In some cases, the operations of this step refer to, or may be performed by, circuitry for waking and/or code for waking as described with reference to FIG. 12.

In some aspects, the signaling comprises at least one of: physical layer signaling, medium access control (MAC) signaling, or radio resource control (RRC) signaling.

In some aspects, the method 1000 further includes outputting an indication indicating at least one of: that the apparatus is to place at least one function in a low power state lower than a current power state, how long the at least one function is to be in the low power state, or that the apparatus is to bring the at least one function out of the low power state earlier than previously indicated. In some cases, the operations of this step refer to, or may be performed by, circuitry for outputting and/or code for outputting as described with reference to FIG. 12.

In some aspects, the signaling indicates at least one of: a schedule associated with performing one or more tasks involved in the coordinated computation; or a schedule associated with waking up to participate in the coordinated computation.

In some aspects, the signaling is obtained from a network entity; and the method further comprises obtaining additional signaling, from the network entity, indicating the network entity is capable of providing the signaling.

In some aspects, the method 1000 further includes outputting signaling indicating the apparatus is capable of processing the signaling. In some cases, the operations of this step refer to, or may be performed by, circuitry for outputting and/or code for outputting as described with reference to FIG. 12.

In some aspects, the signaling is protected via at least one of: a radio network temporary identifier (RNTI); a transmitter identifier; receiver identifier; or encryption.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

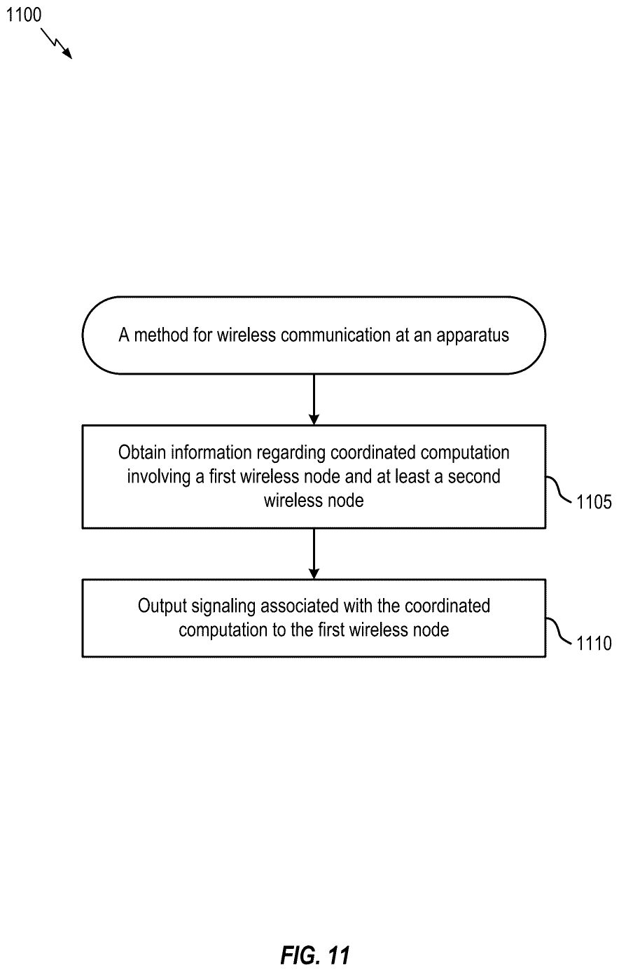

FIG. 11 shows an example of a method 1100 of wireless communication at an apparatus. In some examples, the apparatus is a user equipment, such as a UE 104 of FIGS. 1 and 3. In some examples, the apparatus is a network entity, such as a BS 102 of FIGS. 1 and 3, or a disaggregated base station as discussed with respect to FIG. 2.

Method 1100 begins at step 1105 with obtaining information regarding coordinated computation involving a first wireless node and at least a second wireless node. In some cases, the operations of this step refer to, or may be performed by, circuitry for obtaining and/or code for obtaining as described with reference to FIG. 12.

Method 1100 then proceeds to step 1110 with outputting signaling associated with the coordinated computation to the first wireless node. In some cases, the operations of this step refer to, or may be performed by, circuitry for outputting and/or code for outputting as described with reference to FIG. 12.

In some aspects, the signaling comprises at least one of: a paging signal; a wake-up signal; unicast signaling; multicast signaling; or broadcast signaling.

In some aspects, the signaling indicates an intent of the second wireless node to participate in the coordinated computation with the first wireless node.

In some aspects, the coordinated computation comprises at least one task involving the first wireless node; and the signaling is designed to cause the first wireless node to wake up at least one function at the apparatus in preparation of performing the at least one task.

In some aspects, the method 1100 further includes obtaining, from the first wireless node, a report indicating a time needed for at least one of: initialization of the at least one task. In some cases, the operations of this step refer to, or may be performed by, circuitry for obtaining and/or code for obtaining as described with reference to FIG. 12.

In some aspects, the method 1100 further includes waking up for the at least one function, wherein the signaling is output based on the time indicated in the report. In some cases, the operations of this step refer to, or may be performed by, circuitry for waking and/or code for waking as described with reference to FIG. 12.

In some aspects, the signaling comprises at least one of: physical layer signaling, medium access control (MAC) signaling, or radio resource control (RRC) signaling.

In some aspects, the method 1100 further includes obtaining an indication at least one of: that the first wireless node is to place at least one function in a low power state lower than a current power state, how long the at least one function is to be in the low power state, or that the first wireless node is to bring the at least one function out of the low power state earlier than previously indicated, wherein the signaling is output based on the indication. In some cases, the operations of this step refer to, or may be performed by, circuitry for obtaining and/or code for obtaining as described with reference to FIG. 12.

In some aspects, the signaling indicates at least one of: a schedule associated with performing one or more tasks involved in the coordinated computation; or a schedule associated with waking up to participate in the coordinated computation.

In some aspects, the method 1100 further includes obtaining signaling indicating the first wireless node is capable of processing the signaling. In some cases, the operations of this step refer to, or may be performed by, circuitry for obtaining and/or code for obtaining as described with reference to FIG. 12.

In some aspects, the signaling is protected via at least one of: a radio network temporary identifier (RNTI); a transmitter identifier; receiver identifier; or encryption.

In one aspect, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative steps are possible consistent with this disclosure.

### Example Communications Device(s)

FIG. 12 depicts aspects of an example communications device 1200. In some aspects, communications device 1200 is a user equipment, such as UE 104 described above with respect to FIGS. 1 and 3. In some aspects, communications device 1200 is a network entity, such as BS 102 of FIGS. 1 and 3, or a disaggregated base station as discussed with respect to FIG. 2.

The communications device 1200 includes a processing system 1205 coupled to the transceiver 1285 (e.g., a transmitter and/or a receiver). In some aspects (e.g., when communications device 1200 is a network entity), processing system 1205 may be coupled to a network interface 1295 that is configured to obtain and send signals for the communications device 1200 via communication link(s), such as a backhaul link, midhaul link, and/or fronthaul link as described herein, such as with respect to FIG. 2. The transceiver 1285 is configured to transmit and receive signals for the communications device 1200 via the antenna 1290, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1245 via a bus 1280. In certain aspects, the computer-readable medium/memory 1245 is configured to store instructions (e.g., computer-executable code) that when executed by the one or more processors 1210, cause the one or more processors 1210 to perform the method 1000 described with respect to FIG. 10, or any aspect related to it; and the method 1100 described with respect to FIG. 11, or any aspect related to it. Note that reference to a processor performing a function of communications device 1200 may include one or more processors 1210 performing that function of communications device 1200.

In the depicted example, computer-readable medium/memory 1245 stores code (e.g., executable instructions), such as code for obtaining 1250, code for performing 1255, code for initiating 1260, code for reporting 1265, code for waking 1270, and code for outputting 1275. Processing of the code for obtaining 1250, code for performing 1255, code for initiating 1260, code for reporting 1265, code for waking 1270, and code for outputting 1275 may cause the communications device 1200 to perform the method 1000 described with respect to FIG. 10, or any aspect related to it; and the method 1100 described with respect to FIG. 11, or any aspect related to it.

The one or more processors 1210 include circuitry configured to implement (e.g., execute) the code stored in the computer-readable medium/memory 1245, including circuitry for obtaining 1215, circuitry for performing 1220, circuitry for initiating 1225, circuitry for reporting 1230, circuitry for waking 1235, and circuitry for outputting 1240. Processing with circuitry for obtaining 1215, circuitry for performing 1220, circuitry for initiating 1225, circuitry for reporting 1230, circuitry for waking 1235, and circuitry for outputting 1240 may cause the communications device 1200 to perform the method 1000 described with respect to FIG. 10, or any aspect related to it; and the method 1100 described with respect to FIG. 11, or any aspect related to it.

Various components of the communications device 1200 may provide means for performing the method 1000 described with respect to FIG. 10, or any aspect related to it; and the method 1100 described with respect to FIG. 11, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1285 and the antenna 1290 of the communications device 1200 in FIG. 12. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1285 and the antenna 1290 of the communications device 1200 in FIG. 12.

### Example Clauses

Implementation examples are described in the following numbered clauses:

Clause 1: A method for wireless communication at an apparatus (e.g., a wireless node), comprising: obtaining signaling associated with coordinated computation involving a wireless node and the apparatus; and performing one or more actions based on the signaling.

Clause 2: The method of Clause 1, wherein the signaling comprises at least one of: a paging signal; a wake-up signal; unicast signaling; multicast signaling; or broadcast signaling.

Clause 3: The method of any one of Clauses 1-2, wherein the signaling indicates an intent of the wireless node to participate in the coordinated computation with the apparatus.

Clause 4: The method of any one of Clauses 1-3, wherein: the coordinated computation comprises at least one task involving the apparatus; and the one or more actions comprise at least one of initiating, resuming, or stopping the task.

Clause 5: The method of Clause 4, wherein the one or more actions further comprise waking up at least one function at the apparatus in preparation of performing the at least one task.

Clause 6: The method of Clause 5, wherein the signaling indicates at least one of the at least one task or the at least one function.

Clause 7: The method of Clause 5, further comprising reporting a time needed for at least one of: initialization of the at least one task; and waking up for the at least one function.

Clause 8: The method of any one of Clauses 1-7, wherein the signaling comprises at least one of: physical layer signaling, medium access control (MAC) signaling, or radio resource control (RRC) signaling.

Clause 9: The method of any one of Clauses 1-8, further comprising outputting an indication indicating at least one of: that the apparatus is to place at least one function in a low power state lower than a current power state, how long the at least one function is to be in the low power state, or that the apparatus is to bring the at least one function out of the low power state earlier than previously indicated.

Clause 10: The method of any one of Clauses 1-9, wherein the signaling indicates at least one of: a schedule associated with performing one or more tasks involved in the coordinated computation; or a schedule associated with waking up to participate in the coordinated computation.

Clause 11: The method of any one of Clauses 1-10, wherein: the signaling is obtained from a network entity; and the method further comprises obtaining additional signaling, from the network entity, indicating the network entity is capable of providing the signaling.

Clause 12: The method of any one of Clauses 1-11, further comprising outputting signaling indicating the apparatus is capable of processing the signaling.

Clause 13: The method of any one of Clauses 1-12, wherein the signaling is protected via at least one of: a radio network temporary identifier (RNTI); a transmitter identifier; receiver identifier; or encryption.

Clause 14: A method for wireless communication at an apparatus (e.g., a wireless node), comprising: obtaining information regarding coordinated computation involving a first wireless node and at least a second wireless node; and outputting signaling associated with the coordinated computation to the first wireless node.

Clause 15: The method of Clause 14, wherein the signaling comprises at least one of: a paging signal; a wake-up signal; unicast signaling; multicast signaling; or broadcast signaling.

Clause 16: The method of any one of Clauses 14-15, wherein the signaling indicates an intent of the second wireless node to participate in the coordinated computation with the first wireless node.

Clause 17: The method of any one of Clauses 14-16, wherein: the coordinated computation comprises at least one task involving the first wireless node; and the signaling is designed to cause the first wireless node to wake up at least one function at the apparatus in preparation of performing the at least one task.

Clause 18: The method of Clause 17, further comprising obtaining, from the first wireless node, a report indicating a time needed for at least one of: initialization of the at least one task; and waking up for the at least one function, wherein the signaling is output based on the time indicated in the report.

Clause 19: The method of any one of Clauses 14-18, wherein the signaling comprises at least one of: physical layer signaling, medium access control (MAC) signaling, or radio resource control (RRC) signaling.

Clause 20: The method of any one of Clauses 14-19, further comprising obtaining an indication at least one of: that the first wireless node is to place at least one function in a low power state lower than a current power state, how long the at least one function is to be in the low power state, or that the first wireless node is to bring the at least one function out of the low power state earlier than previously indicated, wherein the signaling is output based on the indication.

Clause 21: The method of any one of Clauses 14-20, wherein the signaling indicates at least one of: a schedule associated with performing one or more tasks involved in the coordinated computation; or a schedule associated with waking up to participate in the coordinated computation.

Clause 22: The method of any one of Clauses 14-21, further comprising obtaining signaling indicating the first wireless node is capable of processing the signaling.

Clause 23: The method of any one of Clauses 14-22, wherein the signaling is protected via at least one of: a radio network temporary identifier (RNTI); a transmitter identifier; receiver identifier; or encryption.

Clause 24: An apparatus, comprising: at least one memory comprising executable instructions; and at least one processor configured to execute the executable instructions and cause the apparatus to perform a method in accordance with any combination of Clauses 1-23.

Clause 25: An apparatus, comprising means for performing a method in accordance with any combination of Clauses 1-23.

Clause 26: A non-transitory computer-readable medium comprising executable instructions that, when executed by at least one processor of an apparatus, cause the apparatus to perform a method in accordance with any combination of Clauses 1-23.

Clause 27: A computer program product embodied on a computer-readable storage medium comprising code for performing a method in accordance with any combination of Clauses 1-23.

Clause 28: A wireless node (e.g., a UE), comprising: at least one transceiver; at least one memory comprising executable instructions; and at least one processor configured to execute the executable instructions and cause the apparatus to perform a method in accordance with any combination of Clauses 1-13, wherein the at least one transceiver is configured to receive the signaling.

Clause 29: A wireless node (e.g., a network entity), comprising: at least one memory comprising executable instructions; and at least one processor configured to execute the executable instructions and cause the apparatus to perform a method in accordance with any combination of Clauses 14-23, wherein the at least one transceiver is configured to transmit the signaling.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

Means for obtaining, means for performing, means for initiating, means for resuming, means for stopping, means for reporting, means for waking, and means for outputting may comprise one or more processors, such as one or more of the processors described above with reference to FIG. 12.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising instructions; and
one or more processors configured to execute the instructions to cause the apparatus to:
obtain signaling associated with coordinated computation involving a wireless node and the apparatus; and
perform one or more actions based on the signaling.

2. The apparatus of claim 1, wherein the signaling comprises at least one of:
a paging signal;
a wake-up signal;
unicast signaling;
multicast signaling; or
broadcast signaling.

3. The apparatus of claim 1, wherein the signaling indicates an intent of the wireless node to participate in the coordinated computation with the apparatus.

4. The apparatus of claim 1, wherein:
the coordinated computation comprises at least one task involving the apparatus; and
the one or more actions comprise at least one of initiating, resuming, or stopping the task.

5. The apparatus of claim 4, wherein the one or more actions further comprise waking up at least one function at the apparatus in preparation of performing the at least one task.

6. The apparatus of claim 5, wherein the signaling indicates at least one of the at least one task or the at least one function.

7. The apparatus of claim 5, wherein the one or more processors are further configured to execute the instructions to cause the apparatus to report a time needed for at least one of:
initialization of the at least one task; or
waking up for the at least one function.

8. The apparatus of claim 1, wherein the signaling comprises at least one of:
physical layer signaling, medium access control (MAC) signaling, or radio resource control (RRC) signaling.

9. The apparatus of claim 1, wherein the one or more processors are further configured to execute the instructions to cause the apparatus to output an indication indicating at least one of:
that the apparatus is to place at least one function in a low power state lower than a current power state;
how long the at least one function is to be in the low power state; or
that the apparatus is to bring the at least one function out of the low power state earlier than previously indicated.

10. The apparatus of claim 1, wherein the signaling indicates at least one of:
a schedule associated with performing one or more tasks involved in the coordinated computation; or
a schedule associated with waking up to participate in the coordinated computation.

11. The apparatus of claim 1, wherein:
the signaling is obtained from a network entity; and
the one or more processors are further configured to execute the instructions to cause the apparatus to obtain additional signaling, from the network entity, indicating the network entity is capable of providing the signaling.

12. The apparatus of claim 1, wherein the one or more processors are further configured to execute the instructions to cause the apparatus to output signaling indicating the apparatus is capable of processing the signaling.

13. The apparatus of claim 1, wherein the signaling is protected via at least one of:
a radio network temporary identifier (RNTI);
a transmitter identifier;
receiver identifier; or encryption.

14. An apparatus for wireless communication, comprising:
at least one memory comprising instructions; and
one or more processors configured to execute the instructions to cause the apparatus to:
obtain information regarding coordinated computation involving a first wireless node and at least a second wireless node; and
output signaling associated with the coordinated computation to the first wireless node.

15. The apparatus of claim 14, wherein the signaling comprises at least one of:
physical layer signaling;
medium access control (MAC) signaling;
radio resource control (RRC) signaling;
a paging signal;
a wake-up signal;
unicast signaling;
multicast signaling; or
broadcast signaling.

16. The apparatus of claim 14, wherein the signaling indicates an intent of the wireless node to participate in the coordinated computation with the wireless node.

17. The apparatus of claim 14, wherein:
the coordinated computation comprises at least one task involving the first wireless node; and
the signaling is designed to cause the first wireless node to wake up at least one function at the apparatus in preparation of performing the at least one task.

18. The apparatus of claim 17, wherein:
the one or more processors are further configured to execute the instructions to cause the apparatus to obtain, from the first wireless node, a report indicating a time needed for at least one of: initialization of the at least one task; or waking up for the at least one function; and
the signaling is output based on the time indicated in the report.

19. The apparatus of claim 14, wherein:
the one or more processors are further configured to execute the instructions to cause the apparatus to obtain an indication at least one of: that the first wireless node is to place at least one function in a low power state lower than a current power state; how long the at least one function is to be in the low power state; or that the first wireless node is to bring the at least one function out of the low power state earlier than previously indicated;
the signaling is output based on the indication; and
the signaling indicates at least one of:
a schedule associated with performing one or more tasks involved in the coordinated computation; or
a schedule associated with waking up to participate in the coordinated computation.

20. A method for wireless communication at a first wireless node, comprising:
obtaining signaling associated with coordinated computation involving the first wireless node and a second wireless node; and
performing one or more actions based on the signaling.
